(19) United States
(12) Patent Application Publication
(10) Pub. No.: US 2016/0218626 A1
(43) Pub. Date: Jul. 28, 2016

(54) DAMPER CIRCUIT FOR SWITCHED DIMMING

(71) Applicant: Power Integrations, Inc., San Jose, CA (US)

(72) Inventor: Jose Requinton Del Carmen, JR., San Jose, CA (US)

(21) Appl. No.: 14/966,328

(22) Filed: Dec. 11, 2015

Related U.S. Application Data
(60) Provisional application No. 62/108,028, filed on Jan. 26, 2015.

(51) Int. Cl. H02M 3/335

(52) U.S. Cl. CPC H02M 3/33507; H02M 2001/0009

(57) ABSTRACT

Circuitry for damping transitions in an input current of a power converter includes a transistor with a control terminal coupled to receive an impedance control signal and main terminals coupled to variably impede the input current of the power converter in response to the impedance control signal. An impedance control circuit is coupled across input rails of the power converter to provide the impedance control signal. The impedance control circuit includes a first current conduction path coupling the control terminal to a first of the input rails of the power converter, and a second current conduction path coupling the control terminal to a second of the input rails of the power converter. The second of the input rails of the power converter is coupled to the main terminals of the transistor.

### REFERENCE TO RELATED APPLICATION

This application claims the benefit of U.S. Provisional Application No. 62/108,028, filed Jan. 26, 2015.

### BACKGROUND INFORMATION

1. Field of the Disclosure

The present invention relates generally to damper circuits, and more specifically damper circuits for use in power converters.

2. Background

Electronic devices use power to operate. Switched mode power converters are commonly used due to their high efficiency, small size and low weight to power many modern electronics. Conventional wall sockets provide a high voltage alternating current. In a switching power converter a high voltage alternating current (ac) input is converted to provide a regulated direct current (dc) output through an energy transfer element. The switched mode power converter control circuit provides output regulation by sensing the output and controlling it using a closed loop. During operation, a switch is utilized to provide the desired output by varying the duty cycle (typically the ratio of the on time of the switch to the total switching period) of the switch in a switched mode power converter (also referred as a switching power supply or a switched mode power supply).

In one type of dimming for lighting applications, a TRIAC dimmer circuit removes a portion of the ac input voltage to limit the amount of voltage and current supplied to an incandescent lamp. This is known as phase dimming because it is often convenient to designate the position of the missing voltage in terms of a fraction of the period of the ac input voltage measured in degrees. In general, the ac input voltage is a sinusoidal waveform and the period of the ac input voltage is referred to as a full line cycle. As such, half the period of the ac input voltage is referred to as a half line cycle. An entire period has 360 degrees, and a half line cycle has 180 degrees. Typically, the phase angle is a measure of how many degrees (from a reference of zero degrees) of each half line cycle the dimmer circuit removes. As such, removal of half the ac input voltage in a half line cycle by the TRIAC dimmer circuit corresponds to a phase angle of 90 degrees. In another example, removal of a quarter of the ac input voltage in a half line cycle may correspond to a phase angle of 45 degrees.

Although phase angle dimming works well with incandescent lamps that receive the altered ac line voltage directly, it typically creates problems for light emitting diode (LED) lamps driven by a switching power converter. Conventional regulated switching power converters are typically designed to ignore distortions of the ac input voltage and deliver a constant regulated output until a low input voltage causes them to shut off. As such, conventional regulated switching power converters cannot dim LED lamps. Unless a power converter for an LED lamp is specially designed to recognize and respond to the voltage from a TRIAC dimmer circuit in a desirable way, a TRIAC dimmer can produce unacceptable results such as flickering of the LED lamp.

Another difficulty in using TRIAC dimming circuits with LED lamps comes from a characteristic of the TRIAC itself. A TRIAC is a semiconductor component that behaves as a controlled ac switch. In other words, it behaves as an open switch to an ac voltage until it receives a trigger signal at a control terminal, which causes the switch to close. The switch remains closed as long as the current through the switch is above a value referred to as the holding current. Most incandescent lamps use more than enough current from the ac power source to allow reliable and consistent operation of a TRIAC. However, the low current used by efficient power converters to drive LED lamps may not provide enough current to keep a TRIAC conducting for the expected portion of the ac line period. Therefore, conventional power converter controller designs rely on a dummy load sometimes called a bleeder circuit, to take enough extra current from the input of the power converter to keep the TRIAC conducting. In addition, the sharply increasing input voltage when the TRIAC fires during each half line cycle causes an inrush input current ringing which may reverse several times during the half line cycle. During these current reversals, the TRIAC may prematurely turn off and cause flickering in the LED lamp. A series resistor damper may then be utilized to slow down the charging of the input capacitor, and dampen the input current ringing and prevent voltage overshoot of the input capacitor. In general, the damper circuit is external from the integrated circuit of the power converter controller and is implemented with a resistor coupled at the input of the power converter. However, use of the damper resistor alone degrades the overall efficiency of the system.

### SUMMARY

In one implementation, circuitry (143, 443) is for damping transitions in an input current (103, 403) of a power converter. The circuitry comprises a transistor (142, 442) comprising a control terminal coupled to receive an impedance control signal and main terminals coupled to variably impede the input current of the power converter in response to the impedance control signal, an impedance control circuit coupled across the input rails of the power converter to provide the impedance control signal to the control terminal. The impedance control circuit comprises a first current conduction path coupling the control terminal to a first of the input rails of the power converter and a second current conduction path coupling the control terminal to a second of the input rails of the power converter, wherein the second of the input rails of the power converter is coupled to a first of the main terminals of the transistor.

This and other implementations can include one or more of the following features. The circuitry can further comprise a damping resistance (144, 444) to be coupled between the first input rail of the power converter and an input voltage and the transistor is coupled to variably shunt input current of the power converter across the damping resistance in response to the impedance control signal. The first current conduction path can comprise a resistance (132, 432) between the control terminal and the first of the input rails. The second current conduction path can comprise a resistance (140, 440) between the control terminal and the second of the input rails. The transistor can comprise a voltage-controlled transistor and the impedance control signal can be a voltage applied to the control terminal of the voltage-controlled transistor.

In some implementations, during a first portion (T1) of a time that the transistor impedes the input current of the power converter, current conduction along both the first current conduction path and the second current conduction path tends to bias the voltage-controlled transistor to impede the input current of the power converter. During a second portion (T2) of the time the first portion of the time transistor impedes the input current of the power converter, the transistor can be driven in the linear mode.

The circuitry can further comprise a nonparasitic capacitance (138, 438) coupled to store the voltage applied to the control terminal. The circuitry can further comprise a Zener diode (136, 436) coupled to limit a voltage applied to the control terminal of the transistor.

The circuitry can further comprise a resistance (134, 434) coupled between the control terminal and a second of the main terminals of the transistor. The second of the input rails can be a return rail.

In one implementation, a device comprises the circuitry of the embodiment and the power converter. The device can further comprise a rectifier (106) coupled to rectify an ac signal for input into the power converter. The device can further comprise a dimmer circuit (104) coupled to truncate the ac signal rectified by the rectifier. The circuitry can be coupled to increase the impedance of the input current of the power converter relatively quickly in response to relatively fast increases in the input current and to decrease the impedance of the input current relatively slowly in response to relatively slow decreases in the input current. The circuitry can be coupled to decrease the impedance of the input current by the transistor to an approximately zero steady state impedance (T3). The impedance control circuit can be configured to decrease the impedance of the input current by the transistor to a steady state impedance in less than one half of a line cycle.

In another implementation, a device is for damping transitions in an input current (103,403) of a power converter. The device can comprise a damping resistance (144, 444) to be coupled between a first input rail of the power converter and an input voltage, a bypass transistor (142, 442) comprising a control terminal coupled to receive a bypass control signal and main terminals coupled to selectively shunt the input current of the power converter across the damping resistance in response to the bypass control signal, and a bypass control circuit coupled across the input rails of the power converter to provide the bypass control signal to the control terminal of the bypass transistor. The bypass control circuit can comprise a nonparasitic capacitance (138, 438) coupled between the control terminal of the bypass transistor and a first of the main terminals of the bypass transistor, a first resistance (140, 440) coupled between the control terminal of the bypass transistor and a second of the main terminals of the bypass transistor, and a current conduction path between the control terminal of the bypass transistor and a second input rail of the power converter.

This and other implementations can include one or more of the following features. The current conduction path between the control terminal and the second input rail can comprise a resistance (132, 432). The bypass transistor can comprise a MOSFET. The bypass control circuit can be configured so that nonparasitic capacitance supports voltages to drive the MOSFET in the linear mode. The device can further comprise a Zener diode (136, 436) coupled to limit a voltage applied to the control terminal of the bypass transistor. The device can further comprise a second resistance (134, 434) coupled between the control terminal and a first of the main terminals of the transistor. The first of the input rails can be a return rail. The circuitry can be coupled to decrease shunting of the input current of the power converter relatively quickly in response to relatively fast increases in the input current and to increase shunting of the input current relatively slowly in response to relatively slow decreases in the input current. The circuitry can be coupled to increase shunting of the input current until approximately all of the input current is shunted across the damping resistance (T3). The impedance control circuit can be configured to increase shunting of the input current by the transistor to a steady state impedance in less than one half of a line cycle.

In another implementation, a power supply comprises the device of any one of the previous implementations, the power converter, and a rectifier (106) coupled to rectify an ac signal for input into the power converter.

In another implementation, a circuit is for use in a power converter. The circuit comprises a damping resistance (144, 444) having a first terminal coupled to an output of a rectifier circuit (106), the damping resistance having a second terminal coupled to a first terminal of an input filter capacitor (108, 408) of the power converter, wherein a second terminal of the input filter capacitor is to be coupled to the output of the rectifier circuit, a transistor (142, 442) having a first main terminal coupled to the first terminal of the damping resistance, the transistor having a second main terminal coupled to the second terminal of the damping resistance, and a control circuit including a first resistance, a second resistance, and a first capacitance. The first resistance (132, 432) is coupled between the control terminal of the transistor and the second terminal of the input filter capacitor. The second resistance (140, 440) is coupled between the control terminal of the transistor and the first terminal of the input filter capacitor. The first capacitance (138, 438) is coupled between the control terminal of the transistor and the first terminal of the damping resistance.

This and other implementations can include one or more of the following features. The input filter capacitor can be coupled across a primary winding (112, 412) and a switch (126, 426) of the power converter. The switch of the power converter can be coupled to be opened and closed in response to a drive signal (129, 429) to regulate an output of the power converter. The rectifier circuit (106) can be coupled to receive a dimmer voltage from a dimmer circuit (104). The dimmer circuit can be coupled to disconnect a fraction of a period of each half line cycle of an ac input voltage from the power converter. The damping resistance can be coupled to reduce a ringing in an input current of the power converter caused by the dimmer circuit when the transistor is set by the control circuit to have a high impedance between the main terminals. The damping resistance can be coupled to be bypassed by the transistor when the transistor is set by the control circuit to have a low impedance between the main terminals.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram illustrating an example power converter in accordance with the teachings of the present invention.

FIG. 2A is a waveform illustrating an example ac voltage in accordance with the teachings of the present invention.

FIG. 2B is a waveform illustrating an example output voltage of a dimmer circuit in accordance with the teachings of the present invention.

FIG. 2C is a waveform illustrating an example output of a rectifier circuit in accordance with the teachings of the present invention.

FIG. 3A is a waveform illustrating an example of the input current from the output dimmer circuit in accordance with the teachings of the present invention.

FIG. 3B illustrates the voltage of V_{R4} of the damper circuit from FIG. 1 in accordance with the teachings of the present invention.

FIG. 4 is a functional block diagram illustrating another example power converter with a damper circuit in accordance with the teachings of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Examples of a power converter that utilizes a damper circuit are described herein. In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

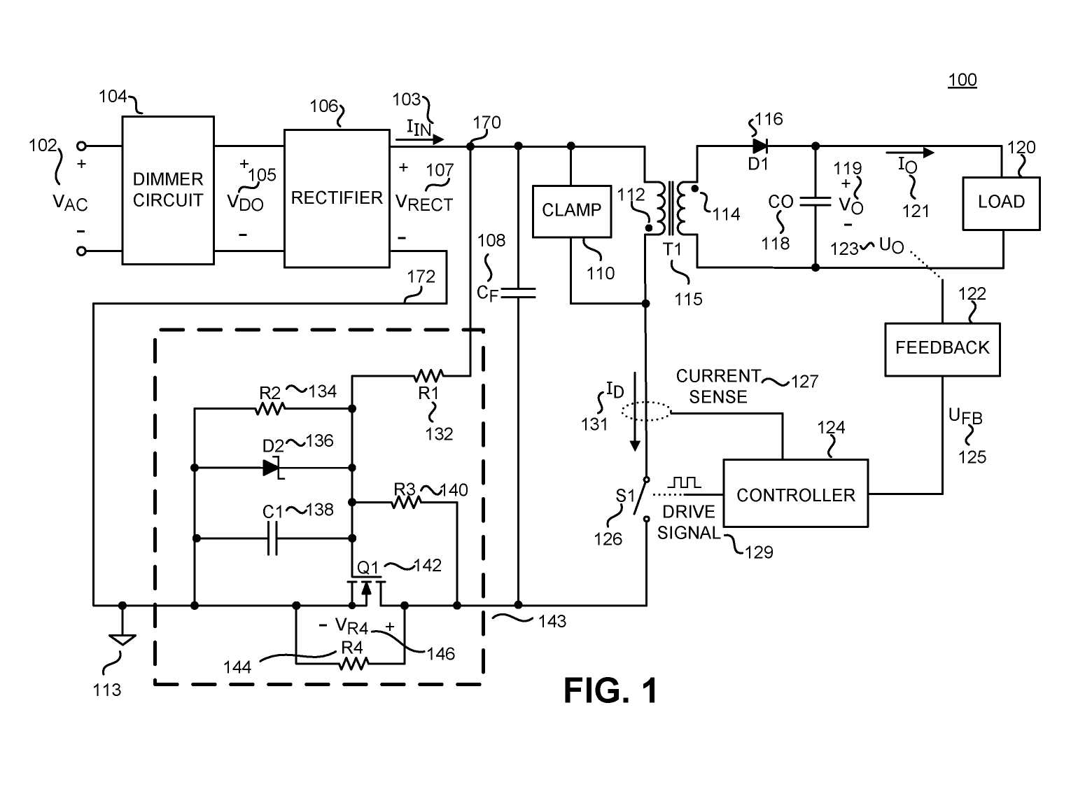

Referring now to FIG. 1, a diagram of an example switching power converter 100 is depicted including ac input voltage V_{AC} 102, a dimmer circuit 104, a bridge rectifier circuit 106, a dimmer voltage V_{DO} 105, a rectified voltage V_{RECT} 107, an energy transfer element T1 115, a primary winding 112 of the energy transfer element T1 115, a secondary winding 114 of the energy transfer element T1 115, a switch S1 126, an input return 113, a clamp circuit 110, an input capacitor C_{F} 108, a rectifier D1 116, an output capacitor C_{O} 118, an output quantity U_{O} 123, an output voltage V_{O} 119, an output current I_{O} 121, a feedback circuit 122, a feedback signal U_{FB} 125, a controller 124, a drive signal 129, a current sense signal 127, and switch current I_{D} 131. Also illustrated in FIG. 1 is a load 120 (e.g., one or more light emitting diodes) coupled to the switching power converter 100. The example switching power converter 100 illustrated in FIG. 1 is configured generally as a flyback regulator, which is one example of a switching power converter topology that may benefit from the teachings of the present disclosure. However, it is appreciated that other known topologies and configurations of switching power converter regulators may also benefit from the teachings of the present disclosure.

Further depicted is a thyristor damper circuit 143 coupled between a first and second terminal 170, 172 of the rectifier circuit. The thyristor damper circuit 143 includes a first resistor R1 132, a second resistor R2 134, a third resistor R3, a fourth resistor R4 144, a second rectifier D2 126, a first capacitor C1 138, and a transistor Q1 142. In one example, transistor Q1 142 is a MOSFET. The thyristor damper circuit 143 further includes a voltage V_{R4} 146 across the fourth resistor 144.

The switching power converter 100 provides output power to the load 120, such as a light emitting diode (LED) for example, from an unregulated input voltage such as the ac input voltage V_{AC} 102. The dimmer circuit 104 provides the dimmer voltage V_{DO} 105 in response to the input voltage V_{AC} 102. The dimmer circuit 104 can be any known dimmer circuit such as a thyristor dimmer circuit or a triode for alternating current (TRIAC) dimmer circuit for example. The bridge rectifier 106 provides the rectified voltage V_{RECT} 107 in response to the dimmer voltage V_{DO} 105. The bridge rectifier 104 is coupled to the energy transfer element T1 115. In some embodiments, the energy transfer element T1 115 can be a coupled inductor. In other embodiments, the energy transfer element T1 115 can be a transformer. In the example of FIG. 1, the energy transfer element T1 115 includes two windings, a primary winding 112 and a secondary winding 114. However, it should be appreciated that the energy transfer element T1 115 can have more than two windings if desired. The primary winding 112 is coupled to switch S1 126, which is further coupled to input return 116. In one embodiment, the switch S1 126 can be a transistor such as a metal-oxide-semiconductor field-effect transistor (MOSFET). In another example, controller 124 can be implemented as a monolithic integrated circuit or may be implemented with discrete electrical components or a combination of discrete and integrated components. In addition, the controller 124 and switch S1 126 can be included in an integrated circuit that is manufactured as either a hybrid or monolithic integrated circuit. An open (i.e., ON) switch may conduct current, while a closed (i.e., OFF) switch cannot conduct current.

As shown, the clamp circuit 110 is coupled across the primary winding 112 of the energy transfer element T1 115. The input capacitor C_{F} 108 can couple across the primary winding 112 and switch S1 126. In other words, the input capacitor C_{F} 108 can be coupled to the rectifier 106 and input return 113. The secondary winding 114 of the energy transfer element T1 115 is coupled to the rectifier D1 116. Although the rectifier D1 116 is depicted as a diode in this example, the rectifier D1 116 can be a transistor used as a synchronous rectifier if desired. In this example, the output capacitor C_{O} 118 and the load 120 are coupled to the rectifier D1 116. An output is provided to the load 120 and can be provided as either a regulated output voltage V_{O} 119, regulated output current I_{O} 121, or a combination thereof.

The switched mode power converter 100 further comprises circuitry to regulate the output, which is shown as output quantity U_{O} 123. In general, the regulated output quantity U_{O} 123 is either an output voltage V_{O} 119, output current I_{O} 121, or a combination thereof. The feedback circuit 122 is operative to sense the output quantity U_{O} 123 of the switched mode power converter 100 and produces the feedback signal U_{FB} 125 based thereon. In one embodiment, the feedback circuit 122 may sense the output quantity U_{O} 123 from the output of the power converter 100. In other embodiments, the feedback signal U_{FB} 125 can be derived from sensing one or more quantities on the input side of the transformer that are representative of the output quantity U_{O} 123. The feedback circuit 122 is coupled to a terminal of the controller 124 such that the controller 124 receives the feedback signal U_{FB} 125. The controller 124 also includes a terminal for receiving the current sense input signal 127. The current sense input signal 127 is representative of the switch current I_{D} 131 in the switch S1 126. In addition, the switch S1 126 receives the drive signal 129 from the controller 124.

In operation, the switching power converter 100 of FIG. 1 provides output power to the load 120 from an unregulated input such as the ac input voltage V_{AC} 102. The ac input voltage V_{AC} 102 is received by the dimmer circuit 104 and provides the dimmer voltage 105 based thereon. The dimmer circuit 104 can be utilized when the load 120 coupled to the power converter 100 is a light emitting diode (LED) array to limit the amount of power delivered to the power converter 100. As a result, the current delivered to the load of LED arrays is limited and the LED array dims. In one embodiment, the dimmer circuit 104 is a TRIAC dimmer circuit or other suitable switching dimmer circuit. The dimmer circuit 104 disconnects the ac input voltage V_{AC} 102 from the power converter when the ac input voltage V_{AC} 102 crosses zero voltage. After a given amount of time, the dimmer circuit 104 reconnects the ac input voltage V_{AC} 102 with the power converter 100. Depending on the amount of dimming desired, the dimmer circuit 104 controls the amount of time the ac input voltage V_{AC} 102 is disconnected from the power converter 100. In general, more dimming corresponds to a longer period of time during which the dimmer circuit 104 disconnects the ac input voltage V_{AC} 102. For phase dimming applications of LEDs that utilize a TRIAC dimmer circuit, the TRIAC requires a minimum holding current to keep the TRIAC itself from turning off. The controller 124 utilizes the damper circuit 143 to help ensure that the current through the TRIAC does not fall below the holding current of the TRIAC.

The rectifier circuit 104 provides the rectified voltage V_{RECT} 107 in response to the dimmer voltage 105. The input capacitor C_{F} 108 filters the high frequency current from the switch S1 126. In one example, the input capacitor C_{F} 108 has a capacitance large enough such that a dc voltage is applied to the energy transfer element T1 115. However for power converters with power factor correction (PFC), a small input capacitor C_{F} 108 can be utilized to allow the voltage applied to the energy transfer element T1 115 to substantially follow the rectified voltage V_{RECT} 107. As such, the value of the input capacitor C_{F} 108 can be chosen such that the voltage on the input capacitor C_{F} 108 reaches substantially zero during each half-line cycle of the input line voltage. Or in other words, the voltage on the input capacitor C_{F} 108 substantially follows the positive magnitude of the ac input voltage V_{AC} 102.

The thyristor damper circuit 143 dampens input current I_{IN} 103 to reduce ringing when the dimmer circuit 104 switches on. As noted above, when the dimmer circuit 104 switches on, inrush input current ringing occurs, which may reverse several times during the half line cycle. During these current reversals, the TRIAC of the dimmer circuit 104 may prematurely turn off and cause flickering in the LED lamp.

For each switching cycle of the dimmer circuit 104, the thyristor damper circuit 143 dampens the input current I_{IN} 103 for a predetermined time when the dimmer circuit 104 switches on and thereafter ceases to dampen the input current I_{IN} 103 after the predetermined time has lapsed. In one example, a value of the first resistor R1 132 may be 1 MΩ. In another example, the first resistor R1 132 may be a value in the range from 500Ω to 1 MΩ. In one example, the value of the second resistor may be 100 kΩ. As such, the thyristor damper circuit 143 reduces ringing when the dimmer circuit 104 switches on. In addition, since the thyristor damper circuit 143 is only on for a portion of the time during which the dimmer circuit 104 is on, embodiments of the present invention may dissipate less power than a conventional damper circuit that dissipates power when an ac voltage is present.

At a first period during a half line cycle of operation, the dimmer circuit 104 switches on and reconnects the ac voltage V_{AC} 102. The peak of the inrush current occurs at a first time period associated with the moment that the dimmer circuit 104 switches on. At this time, transistor Q1 142 is currently turned OFF and therefore impedes the input current of the power converter. The capacitor C1 138 begins to charge. In one example, the value of the capacitor C1 138 is a range from 1 nF to 10 nF. The amount that capacitor C1 138 charges to is set by the first resistor R1 132 and the second resistor 134. The first resistor R1 132 and the second resistor R2 134 form a voltage divider.

At a second time period during the half line cycle, the capacitor C1 138 is at a voltage that is greater than the gate source voltage V_{GS} of transistor Q1 142. The second rectifier D2 136 protects transistor Q1 142 from exceeding a gate source voltage V_{GS}. Capacitor C1 138 provides a control signal to the transistor Q1 142. Transistor Q1 142 operates in linear mode and impedes the input current of the power converter with a slope that is dictated by the third resistor R3 140. In one example, the value of the third resistor R3 10 kΩ. The transistor Q1 142 prevents the input current I_{IN} 103 from falling below a current threshold known as the holding current of the TRIAC to prevent flickering of the LED.

At a third time period during the half line cycle that occurs near the end of the conduction angle, transistor Q1 142 is turned off. When the dimmer circuit 104 switches off, the input current I_{IN} 103 reduces, which in turns disables the thyristor damper circuit 143. The thyristor damper circuit 143 may then be enabled again when the dimmer circuit 104 switches on for the next half-line cycle.

The switching power converter 100 utilizes the energy transfer element T1 115 to transfer voltage between the primary 112 and the secondary 114 windings. The clamp circuit 118 is coupled to the primary winding 110 to limit the maximum voltage on the switch S1 126. Switch S1 126 is opened and closed in response to the drive signal 129. It is generally understood that a switch that is closed may conduct current and is considered on, while a switch that is open cannot conduct current and is considered off. In operation, the switching of the switch S1 126 produces a pulsating current at the rectifier D1 116. The current in the rectifier D1 116 is filtered by the output capacitor C_{O} 118 to produce a substantially constant output voltage V_{O} 119, output current I_{O} 121, or a combination of the two at the load 120. In some embodiments, the load 120 is an LED array.

The feedback circuit 122 senses the output quantity U_{O} 123 of the power converter 100 to provide the feedback signal U_{FB} 125 to the controller 124. The feedback signal U_{FB} 125 may be a voltage signal or a current signal and provides information regarding the output quantity U_{O} 123 to the controller 124. In addition, the controller 124 receives the current sense input signal 127 which relays the switch current I_{D} 131 in the switch S1 126. The switch current I_{D} 131 may be sensed in a variety of ways, such for example the voltage across a discrete resistor or the voltage across a transistor when the transistor is conducting.

The controller 124 outputs a drive signal 129 to operate the switch S1 126 in response to various system inputs to substantially regulate the output quantity U_{O} 123 to the desired value. In one embodiment, the drive signal 129 may be a rectangular pulse waveform with varying lengths of logic high and logic low sections, with the logic high value corresponding to a closed switch and a logic low corresponding to an open switch. In another embodiment, the drive signal 129 may be comprised of substantially fixed-length logic high (or ON) pulses and regulated by varying the number of ON pulses per number of oscillator cycles.

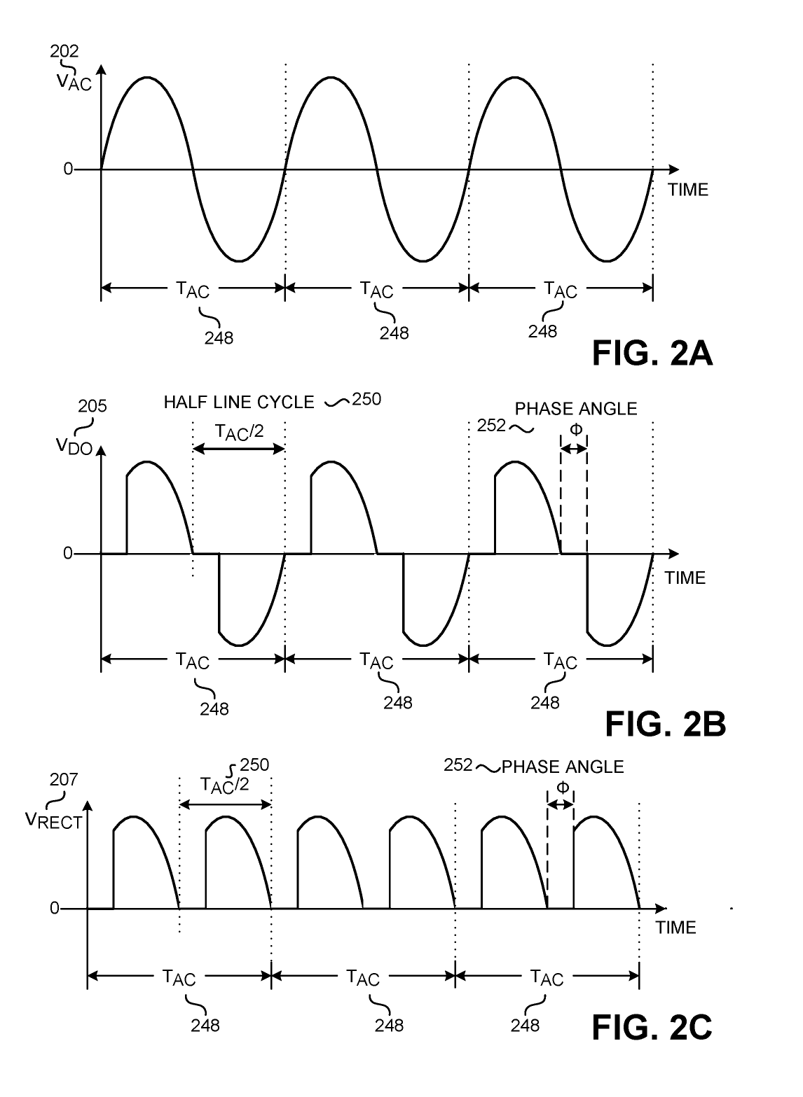

FIGS. 2A-2C illustrate example waveforms of an ac input voltage 202, a dimmer output voltage 205, and a rectified input voltage 207, in accordance with the teachings of the present disclosure. Ac input voltage 202, dimmer output voltage 205, and rectified input voltage 207 are possible representations of ac input voltage 102, dimmer output voltage 105, and rectified input voltage 107, respectively, of FIG. 1.

As shown in FIG. 2A, ac input voltage V_{AC} 202 is generally a sinusoidal waveform with a period denoted as a full line cycle T_{AC} 248. A full line cycle T_{AC} 248 of ac input voltage V_{AC} 202 is denoted as the length of time between every other zero-crossing. When expressed as an angular displacement instead of time, a full line cycle spans 360 degrees, with 180 degrees between zero crossings.

Now referring to dimmer output voltage 205 of FIG. 2B, the half line cycle 250 of the ac input voltage V_{AC} 202 is denoted as the length of time between consecutive zero-crossings. The phase angle Φ 252 is measured as how many degrees (from a reference of zero degrees) the dimmer circuit 102 disconnects the input voltage V_{AC} 202. For leading edge dimming, dimmer circuit 102 disconnects the ac input voltage V_{AC} 202 from power converter 100 when the ac input voltage V_{AC} 202 substantially crosses zero voltage. After a given amount of time, the dimmer circuit 102 reconnects ac input voltage V_{AC} 202 with power converter 100 and the dimmer output voltage V_{DO} 205 substantially follows the ac input voltage V_{AC} 202. In other words, the dimmer circuit 102 removes a portion of the ac input voltage 202 to provide the dimmer output voltage V_{DO} 205 thus limiting the amount of power supplied to a load (such as an LED lamp).

FIG. 2C illustrates that at the beginning of each half line cycle 250, rectified input voltage V_{IN} 207 is substantially equal to zero, corresponding to the time that the dimmer circuit 102 disconnects the ac input voltage V_{AC} 202 from the power converter. When the dimmer circuit 102 reconnects the ac input voltage V_{AC} 202 to the power converter, the rectified input voltage V_{IN} 207 substantially follows the positive magnitude of the dimmer output voltage V_{DO} 205 and the ac input voltage V_{AC} 202 (i.e., V_{IN}=|V_{DO}|). As shown, dimmer output voltage V_{DO} 205 sharply changes from zero to substantially follow the ac input voltage V_{AC} 202 when dimmer circuit 102 reconnects the ac input voltage 202.

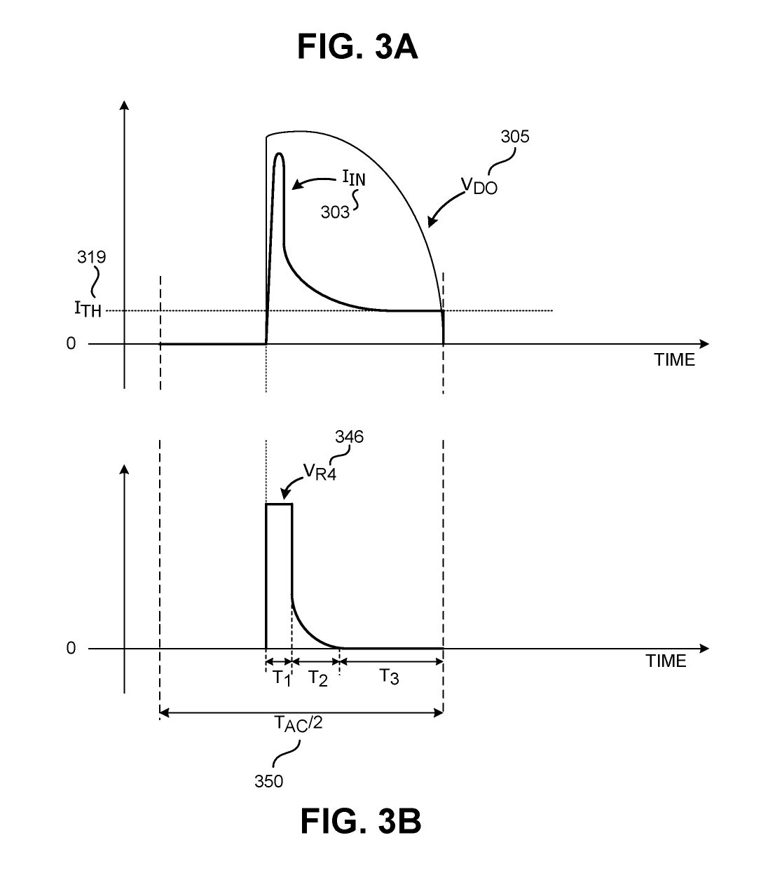

FIG. 3A illustrates a waveform of the output dimmer voltage V_{DO} 305 and the associated input current I_{IN} 303 during a half line cycle. FIG. 3B illustrates the voltage of R4 V_{R4} 346 of the damper circuit from FIG. 1.

When the dimmer circuit is turned on, an inrush of input current I_{IN} 303 occurs. At a time period T1, the transistor Q1 142 from FIG. 1 impedes the input current of the power converter, current conduction along both the first current conduction path and the second current conduction path tends to bias the voltage-controlled transistor Q1 to impede the input current of the power converter, and the voltage across V_{R4} 346 rises to a constant value. Transistor Q1 142 is turned OFF during this time period. At a second time period T2, the capacitor C1 138 is sufficiently charged such that transistor Q1 142 operates in linear mode. The slope of V_{R4} 346 is set by the third resistor R3. At the third time period T3 that occurs near the end of the half line cycle, the voltage V_{R4} 346 is at a value substantially zero such that the transistor Q1 142 turns OFF.

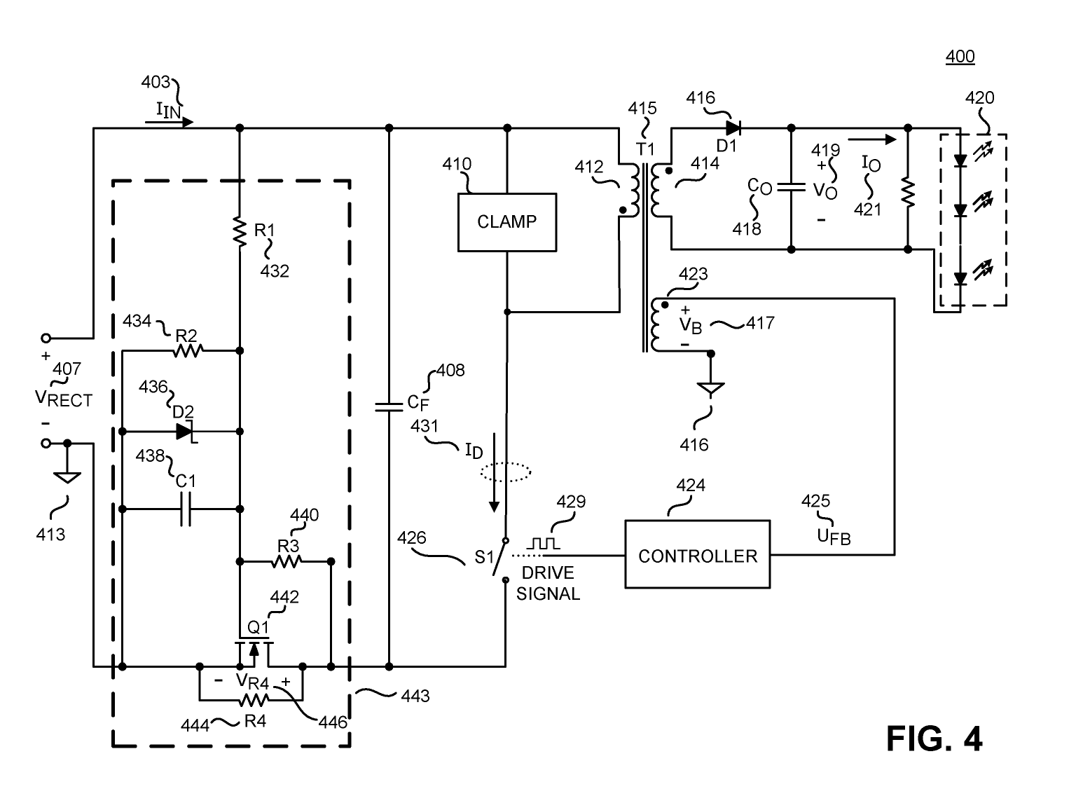

FIG. 4 illustrates another power converter 400 similar to FIG. 1 that further includes a bias winding 423. In operation, the bias winding 423 produces a bias voltage V_{B} 417 that is responsive to the output voltage V_{O} 419 when the output diode D1 416 coupled to secondary winding 414 conducts. The feedback signal U_{FB} 425 is representative of the output voltage V_{O} 419 during at least a portion of an OFF time of switch S1 426. During the on-time of the switch S1 427, the bias winding 423 produces a bias voltage V_{B} 417 in is response to the input voltage V_{RECT} 407.

It is appreciated that many variations are possible in the use of a bias winding to sense an output voltage V_{O} 419 and for providing sensing while also providing power to a controller with galvanic isolation. For example, a bias winding may apply a rectifier and a capacitor similar to rectifier D1 416 and capacitor C_{O} 418, respectively, to produce a dc bias voltage while providing an ac feedback signal from the anode of the rectifier. As such, additional passive components such as resistors may be used on the bias winding 423 to scale the voltage from the winding to a value that is more suitable to be received by controller 424.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. Circuitry for damping transitions in an input current of a power converter, the circuitry comprising:
a transistor comprising:
a control terminal coupled to receive an impedance control signal; and
main terminals coupled to variably impede the input current of the power converter in response to the impedance control signal;
an impedance control circuit coupled across input rails of the power converter to provide the impedance control signal to the control terminal, the impedance control circuit comprising:
a first current conduction path coupling the control terminal to a first of the input rails of the power converter; and
a second current conduction path coupling the control terminal to a second of the input rails of the power converter, wherein the second of the input rails of the power converter is coupled to the main terminals of the transistor.

2. The circuitry of claim 1 further comprising a damping resistance to be coupled between the first input rail of the power converter and an input voltage, wherein the transistor is coupled to variably shunt input current of the power converter across the damping resistance in response to the impedance control signal.

3. The circuitry of claim 1, wherein the first current conduction path comprises a resistance between the control terminal and the first of the input rails.

4. The circuitry of claim 1, wherein the second current conduction path comprises a resistance between the control terminal and the second of the input rails.

5. The circuitry of claim 2, wherein the transistor comprises a voltage-controlled transistor, and wherein the impedance control signal is a voltage applied to the control terminal of the voltage-controlled transistor.

6. The circuitry of claim 5, wherein during a first portion of a time that the transistor impedes the input current of the power converter, current conduction along both the first current conduction path and the second current conduction path tends to bias the voltage-controlled transistor to impede the input current of the power converter.

7. The circuitry of claim 6, wherein during a second portion of the time that the transistor impedes the input current of the power converter, the transistor is driven in linear mode.

8. The circuitry of claim 7 further comprising a nonparasitic capacitance coupled to store the voltage applied to the control terminal.

9. The circuitry of claim 8 further comprising a Zener diode coupled to limit a voltage applied to the control terminal of the transistor.

10. The circuitry of claim 9 further comprising a resistance coupled between the control terminal and a second of the main terminals of the transistor.

11. A device for damping transitions in an input current of a power converter, the device comprising:
a damping resistance to be coupled between a first input rail of the power converter and an input voltage;
a bypass transistor comprising:
a control terminal coupled to the receive a bypass control signal; and
main terminals coupled to selectively shunt the input current of the power converter across the damping resistance in response to the bypass control signal;
a bypass control circuit coupled across the input rails of the power converter to provide the bypass control signal to the control terminal of the bypass transistor, the bypass control circuit comprising:
a nonparasitic capacitance coupled between the control terminal of the bypass transistor and a first of the main terminals of the bypass transistor;
a first resistance coupled between the control terminal of the bypass transistor a second of the main terminals of the bypass transistor; and
a current conduction path between the control terminal of the bypass transistor and a second input rail of the power converter.

12. The device of claim 11, wherein the current conduction path between the control terminal and the second input rail comprises a resistance.

13. The device of claim 12, wherein the bypass transistor comprises a MOSFET, and wherein the bypass control circuit is configured so that nonparasitic capacitance supports voltages to drive the MOSFET in the linear mode.

14. The device of claim 13 further comprising a Zener diode coupled to limit a voltage applied to the control terminal of the bypass transistor.

15. The device of claim 14 further comprising a second resistance coupled between the control terminal and a first of the main terminals of the transistor.

16. The device of claim 11, wherein the second of the input rails is a return rail.

17. The device of claim 11, wherein the device is coupled to decrease shunting of the input current of the power converter relatively quickly in response to relatively fast increases in the input current and to increase shunting of the input current relatively slowly in response to slow decreases in the input current.

18. The device of claim 11, wherein the device is coupled to increase shunting of the input current rail approximately all of the input current is shunted across the damping resistance.

19. The device of claim 11, wherein the impedance control circuit is configured to increase shunting of the input current by the transistor to a steady state impedance in less than one half of a line cycle.

20. A circuit for use in a power converter, the circuit comprising;
a damping resistance having a first terminal coupled to an output of a rectifier circuit, the damping resistance having a second terminal coupled to a first terminal of an input filter capacitor of the power converter, wherein a second terminal of the input filter capacitor is to be coupled to the second terminal of the damping resistance;
a transistor having a first main terminal coupled to the first terminal of the damping resistance, the transistor having a second main terminal coupled to the second terminal of the damping resistance; and
a control circuit including a first resistance, a second resistance, and a first capacitance, wherein:
the first resistance is coupled between the control terminal of the transistor and the second terminal of the input filter capacitor,
the second resistance is coupled between the control terminal of the transistor and the first terminal of the input capacitor, and
the first capacitance is coupled between the control terminal of the transistor and the first terminal of the damping resistance.

21. The circuit of claim 20 wherein the input filter capacitor is coupled across a primary winding, and a switch of the power converter, wherein the switch of the power converter is coupled to be opened and closed in response to a drive signal to regulate an output of the power converter.

22. The circuit of claim 20, wherein the rectifier is coupled to receive a dimmer voltage from a dimmer circuit, wherein the dimmer circuit is coupled to disconnect a fraction of a period of each half line cycle of an input voltage from the power converter.

23. The circuit of claim 20, wherein the damping resistance is coupled to reduce a ringing in an input current of the power converter caused by the dimmer circuit when the transistor is set by the control circuit to have a high impedance between the main terminals.

24. The circuit of claim 20, wherein the damping resistance is coupled to be bypassed by the transistor when the transistor is set by the control circuit to have a low impedance between the main terminals.
